(19) United States
(12) Patent Application Publication
(10) Pub. No.: US 2009/0173368 A1
(43) Pub. Date: Jul. 9, 2009

(54) DRAIN PUMP ASSEMBLY FOR A DISHWASHER AND ASSOCIATED DEVICE AND METHOD

(75) Inventor: John C. Bragg, Goldsboro, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 11/971,535

(22) Filed: Jan. 9, 2008

(51) Int. Cl. A47L 15/08; A47L 15/42; G10K 11/00

(52) U.S. Cl. 134/58 D; 181/200

(57) ABSTRACT

A noise-reducing device for a drain pump of a dishwasher is provided, wherein the drain pump includes a pump motor operably engaged with a pump mechanism disposed within a pump body. The drain pump is adapted to remove dishwashing fluid from a sump of the dishwasher. Such a noise-reducing device comprises a cover member adapted to substantially conformally-encompass the pump body of the drain pump, exclusively of the pump motor, to reduce transmission therethrough of noise generated by the pump mechanism during operation of the drain pump. An acoustic liner is disposed between the cover member and the pump body of the drain pump, in substantial correspondence with the cover member and exclusively of the pump motor. The acoustic liner is configured to further reduce transmission therethrough of noise generated by the pump mechanism during operation of the drain pump. Associated devices and methods are also provided.

### BACKGROUND OF THE INVENTION

1. Field of the Invention

The present disclosure relates to dishwashers and, more particularly, to a drain pump for a dishwasher and associated device and method.

2. Description of Related Art

A dishwasher includes a front-opening wash tub for containing the dishware to be washed. Generally, the tub includes a sump disposed at the lower end thereof. Water sprayed from the spray arms within the tub, onto the dishware therein, drains into the sump along with food soils and debris from the dishware. Because the water collected in the sump is re-circulated through the spray arms during the wash and rinse cycles, the dishwasher usually includes a filtration system associated with the sump and/or the circulation pump (which pumps the water through the spray arms). The filtration system is configured to remove the food soils and debris from the water being circulated by the circulation pump during the wash and rinse cycles.

Upon completion of the respective wash and rinse cycle, the water is pumped out of the sump to the house sewer line via a drain system disposed or otherwise engaged with the sump. The drain system typically includes a drain pump for pumping the water to the house sewer line. In some instances, the drain pump or drain system may include a disposal/chopper/macerator device for reducing the size of the food soils and debris removed from the dishware, during the drain cycle. One issue with the drain pump, however, is the high noise level that may be produced thereby. In this regard, the “drain pump” typically includes a pump body or housing, wherein the pump mechanism in the pump body/housing (for pumping the water from the dishwasher) is driven by an electric motor engaged therewith. In some instances, the noise produced by the drain pump originates from the pump mechanism housed by the pump body/housing, rather than the motor.

Thus, there exists a need for an apparatus, device, and/or method for reducing or containing the noise generated by the drain pump of a dishwasher, particularly during operation thereof.

### BRIEF SUMMARY OF THE INVENTION

The above and other needs are met by the present disclosure which, in one embodiment, provides noise-reducing device for a drain pump of a dishwasher, wherein the drain pump includes a pump motor operably engaged with a pump mechanism disposed within a pump body, and wherein the drain pump is adapted to remove dishwashing fluid from a sump of the dishwasher. Such a noise-reducing device comprises a cover member adapted to substantially conformally-encompass the pump body of the drain pump, exclusively of the pump motor, so as to reduce transmission therethrough of noise generated by the pump mechanism during operation of the drain pump. An acoustic liner is disposed between the cover member and the pump body of the drain pump, in substantial correspondence with the cover member and exclusively of the pump motor, wherein the acoustic liner configured to further reduce transmission therethrough of noise generated by the pump mechanism during operation of the drain pump.

Another advantageous aspect of the present invention comprises a dishwasher appliance including a front-opening wash tub having a sump disposed at the lower end thereof. Such a dishwasher appliance comprises a drain pump including a pump motor operably engaged with a pump mechanism disposed within a pump body, wherein the drain pump is adapted to remove dishwashing fluid from the sump of the dishwasher. A noise-reducing device is configured to substantially conformally-encompass the pump body of the drain pump, exclusively of the pump motor, so as to reduce transmission therethrough of noise generated by the pump mechanism during operation of the drain pump.

Yet another advantageous aspect of the present invention comprises a method for reducing a noise level associated with a drain pump of a dishwasher, wherein the drain pump includes a pump motor operably engaged with a pump mechanism disposed within a pump body. Such a method comprises substantially conformally-encompassing the pump body of the drain pump, exclusively of the pump motor, with a cover member so as to reduce transmission therethrough of noise generated by the pump mechanism during operation of the drain pump. An acoustic liner is also disposed between the cover member and the pump body of the drain pump, in substantial correspondence with the cover member and exclusively of the pump motor, so as to further reduce transmission therethrough of noise generated by the pump mechanism during operation of the drain pump.

Thus, embodiments of the present disclosure provide many advantages that may include, but are not limited to attenuating and reducing noise emitted from the drain pump of a dishwasher appliance.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates an elevation cross-sectional schematic view of a shroud member adapted to encompass a drain pump according to one embodiment of the present disclosure;

FIG. 2 illustrates a front perspective view of a dishwasher drain pump with a shroud member adapted thereto according to the present disclosure; and

FIG. 3 illustrates a rear perspective view of a dishwasher drain pump with a shroud member adapted thereto according to the present disclosure.

### DETAILED DESCRIPTION OF THE INVENTION

The present disclosure now will be described more fully hereinafter with reference to the accompanying drawings, in which some, but not all embodiments of the disclosure are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

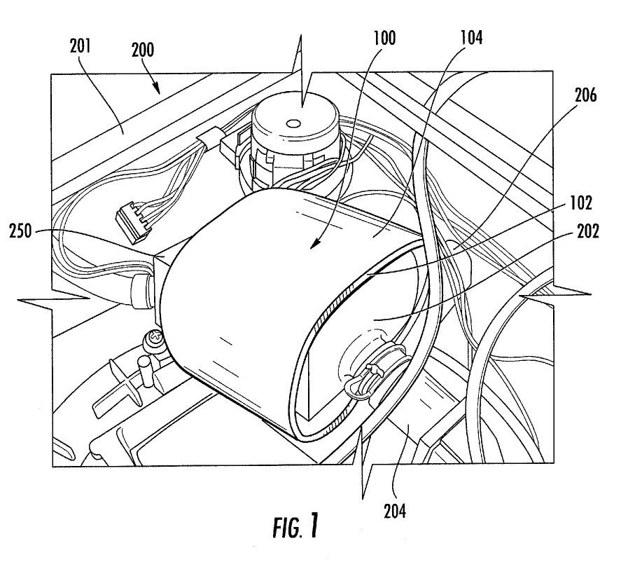

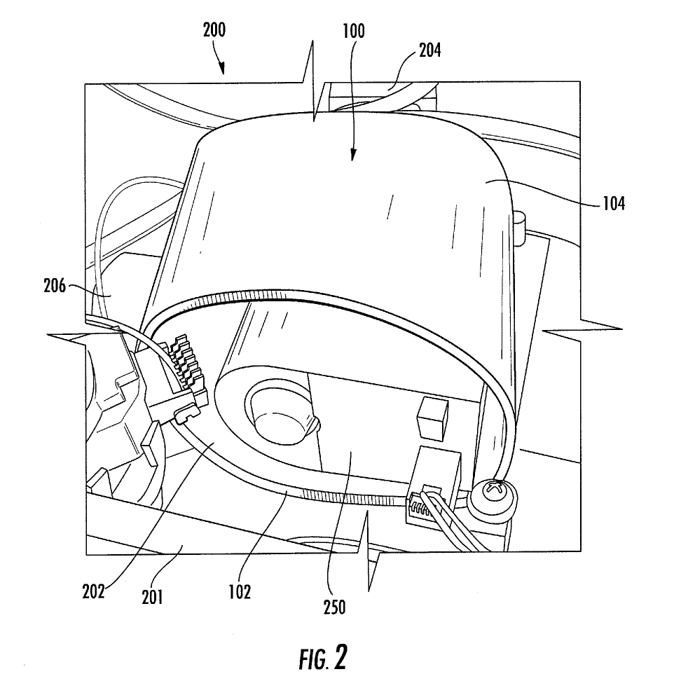

As shown in FIGS. 1 and 2, a drain pump system, generally designated 200, is incorporated into the lower end of a dishwasher tub of a dishwasher appliance. The drain pump system 200 is configured to remove water (or dishwashing fluid) from the tub and into a house sewer line, after the dishwashing fluid is used to wash dishware disposed within the tub. Typically, drain pump system 200 is positioned below the dishwasher tub in a dishwasher base 201, and includes a drain pump for pumping water out of a sump associated with the lower end of the dishwasher tub. The drain pump includes a drain pump motor 250 operably engaged with a pump mechanism disposed within pump body 202, which cooperate to move the water out of the sump and into the house sewer line. Drain pump system 200 further includes an inlet member 204 or hose for transporting water from the sump to the pump body 202 of the drain pump, as well as an outlet member 206 or hose operably engaged with the pump body 202 for transporting the water from the drain pump into the house sewer line. The drain pump motor 250 may be, for example, an electric motor, operably engaged with the pump mechanism within the pump body 202 so as to power/drive the pump mechanism. In some instances, drain pump system 200 may include a macerator device or the like for reducing the size of the food soils and debris removed from the dishware, during the drain cycle, wherein the macerator device may be housed within the pump body 202 (in combination with the pump mechanism) or provided as a separate component from the drain pump.

With continuing reference to FIGS. 1 and 2, a noise-reducing device, generally designated 100, may be provided to absorb and/or block noise produced by the drain pump (i.e., the drain pump mechanism) so as to reduce the overall noise levels associated with the dishwasher during use, wherein a low operational noise level may be a desirable characteristic of dishwashers. In one instance, the noise-reducing device 100 may be configured to conformally-encompass pump body 202 of drain pump system 200, exclusively of the pump motor 250, so as to substantially completely cover the pump body 202. However, according to other embodiments, noise-reducing device 100 may only partially encompass pump body 202, for example, due to size constraints or limitations of drain pump system 200 within the dishwasher appliance.

As particularly illustrated in FIG. 2, and as previously stated, some embodiments provide that the noise-reducing device 100 does not encompass or surround pump motor 250. In such instances, the uncovered pump motor 250 is able to dissipate heat during operation, minimizing the risk of or otherwise preventing the pump motor 250 from overheating as it drives the pump mechanism. However, in other embodiments, noise-reducing device 100 may, in fact, also at least partially, or otherwise substantially completely, encompass the pump motor 250 to further reduce the noise generated by the drain pump system 200 of the dishwasher appliance. In such instances, the pump motor 250 may be provided with an auxiliary cooling system (not shown) such as, for example, a fan, a liquid circulation system, or any other appropriate heat-dissipating measure. Otherwise, the noise-reducing device 100, whether partially or fully covering the pump motor 250, may be configured so as to permit airflow to the pump motor 250 for cooling purposes. Accordingly, by conformally-encompassing at least the drain pump body 202, noise-reducing device 100 at least partially reduces noise produced by the pump mechanism within the pump body 202 by blocking (containing) and/or absorbing noise during operation of the drain pump system 200 which, in turn, at least partially reduces the overall noise emanating from the dishwasher appliance. In instances where the noise-reducing device 100 conformally-encompasses the pump body 202 and extends at least partially about the pump motor 250, the overall noise of the dishwasher appliance during use may be further reduced.

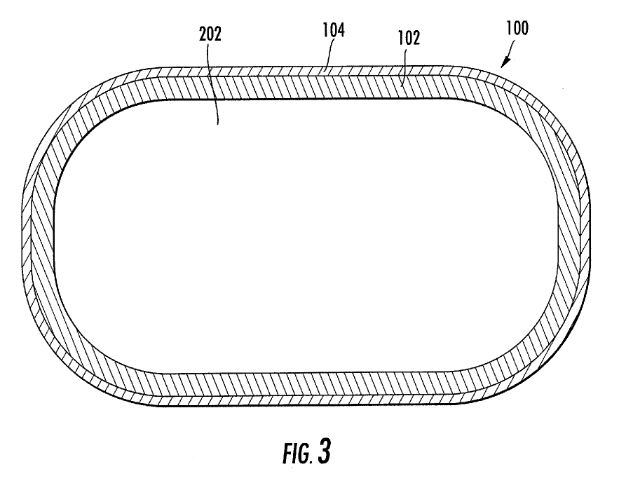

As illustrated in FIG. 3, in some embodiments, noise-reducing device 100 may comprise an acoustic liner 102 and an overlying cover layer 104, each configured to contribute to noise reduction by limiting/attenuating noise produced by the pump mechanism/pump motor 250 of the drain pump. Acoustic liner 102 may be configured to encompass pump body 202 in a conformal manner with an acoustic material that exhibits noise blocking and/or sound absorption properties. For example, acoustic liner 102 may comprise an acoustic foam or a soundproofing composite for noise blocking/sound absorption, wherein such an acoustic liner 102 may, for instance, decrease resonance associated with the drain pump assembly 200 and/or attenuate noise originating from the pump mechanism disposed within pump body 202. Such soundproofing composites may include, for example, high-density, recycled cotton fiber and other suitable layers engaged therewith. According to some embodiments, as previously discussed, acoustic liner 102 may also, in addition to conformally-encompassing pump body 102, at least partially encompassing the pump motor 250. The acoustic liner 102 may be affixed or otherwise secured to or maintained about pump body 202 and, in some instances, the pump motor 250 in any suitable manner, as will be appreciated by one skilled in the art. For example, the acoustic liner 102 may be placed about, sprayed on, or molded about at least the pump body 202 so as to form a conformal relationship therewith.

Cover member 104 may be configured to operably engage acoustic liner 102, in correspondence therewith, in an overlying relationship therewith (i.e., the acoustic liner 102 is disposed between the cover member 104 and the pump body 202). In such instances, the cover member 104 and the acoustic liner 102 cooperate to form the noise-reduction device 100 for blocking and/or absorbing noise produced by the pump mechanism within the pump body 202. Cover member 104 may be applied over the acoustic liner 102 as appropriate such as, for example, by attachment or other mechanical connection, by molding, by spraying, or in any other suitable manner, such that the cover member 104 is disposed adjacent to and substantially covers acoustic liner 102 in a conformal manner. In such instances, the cover member 104, as with the acoustic liner 102, substantially though indirectly conformally-encompasses the pump body 202. In other embodiments, cover layer 104 may, in some instances, be disposed between the acoustic liner 102 and the pump body 202. The cover member 104 may comprise, for instance, a sound blocking and/or absorbing material such as, for example, a thick, high density material with a smooth exterior surface for reducing noise transmission therethrough. The cover member 104 may be rigid, at least partially flexible, or pliable, as appropriate. According to some embodiments, the cover member 104 and/or acoustic liner 102 may include an adhesive side for securing to the other. Further, in embodiments having the cover member 104 disposed outwardly of the acoustic liner 102, cover member 104 may provide a containment mechanism for maintaining acoustic liner 102 adjacent to and in a conformal relationship with pump body 202.

In general, noise reduction device 100 may be configured to at least partially or substantially completely encompass the pump body 202 for reducing noise originating from the pump mechanism disposed within the pump body 202. For example, according to some embodiments, noise reduction device 100 may completely surround the pump body 202 in a conformal manner so as to reduce any noise emanating from the pump body 202, as shown in FIG. 3. In other embodiments, noise reduction device 100 may only partially surround the pump body 202 when, for instance, it is desired that noise not be transmitted in a particular direction with respect to the dishwasher (i.e., the noise only need be reflected/directed in a particular direction) or, for example, when design constraints limit the noise reduction device 100 to covering only certain exposed areas of the pump body 202. Similar considerations also apply, as will be appreciated by one skilled in the art, should the noise reduction device 100 be extended to at least partially surround or encompass the pump motor 250. In such instances, however, the dissipation of heat generated by the pump motor 250 additionally must be considered, as previously discussed.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A noise-reducing device for a drain pump of a dishwasher, the drain pump including a pump motor operably engaged with a pump mechanism disposed within a pump body, the drain pump being adapted to remove dishwashing fluid from a sump of the dishwasher, the noise-reducing device comprising:
a cover member adapted to substantially conformally-encompass the pump body of the drain pump, exclusively of the pump motor, to reduce transmission therethrough of noise generated by the pump mechanism during operation of the drain pump; and
an acoustic liner disposed between the cover member and the pump body of the drain pump, in substantial correspondence with the cover member and exclusively of the pump motor, the acoustic liner configured to further reduce transmission therethrough of noise generated by the pump mechanism during operation of the drain pump.

2. A device according to claim 1, wherein the acoustic liner further comprises an acoustic foam material.

3. A device according to claim 1, wherein the cover member further comprises one of a sound blocking material and a sound absorbing material.

4. A device according to claim 1, wherein at least one of the acoustic liner and the cover layer is adapted to further substantially encompass the pump motor.

5. A dishwasher appliance including a front-opening wash tub having a sump disposed at the lower end thereof, the dishwasher appliance comprising:
a drain pump including a pump motor operably engaged with a pump mechanism disposed within a pump body, the drain pump being adapted to remove dishwashing fluid from the sump of the dishwasher; and
a noise-reducing device configured to substantially conformally-encompass the pump body of the drain pump, exclusively of the pump motor, to reduce transmission therethrough of noise generated by the pump mechanism during operation of the drain pump.

6. An appliance according to claim 5, wherein the noise-reducing device further comprises:
a cover member adapted to substantially conformally-encompass the pump body of the drain pump, exclusively of the pump motor; and
an acoustic liner disposed between the cover member and the pump body of the drain pump, in substantial correspondence with the cover member and exclusively of the pump motor.

7. An appliance according to claim 5, wherein the acoustic liner further comprises an acoustic foam material.

8. An appliance according to claim 5, wherein the cover member further comprises one of a sound blocking material and a sound absorbing material.

9. An appliance according to claim 5, wherein at least one of the acoustic liner and the cover layer is adapted to further substantially encompass the pump motor.

10. A method for reducing a noise level associated with a drain pump of a dishwasher, the drain pump including a pump motor operably engaged with a pump mechanism disposed within a pump body, the method comprising:
substantially conformally-encompassing the pump body of the drain pump, exclusively of the pump motor, with a cover member so as to reduce transmission therethrough of noise generated by the pump mechanism during operation of the drain pump; and
disposing an acoustic liner between the cover member and the pump body of the drain pump, in substantial correspondence with the cover member and exclusively of the pump motor, so as to further reduce transmission therethrough of noise generated by the pump mechanism during operation of the drain pump.

11. A method according to claim 10, wherein substantially conformally-encompassing the pump body further comprises substantially conformally-encompassing the pump body with a cover member comprised of at least one of a sound absorbing material and a sound blocking material.

12. A method according to claim 10, wherein disposing an acoustic liner further comprises disposing an acoustic liner comprised of an acoustic foam material between the cover member and the pump body.
